(19) United States
(12) Patent Application Publication
(10) Pub. No.: US 2003/0173918 A1
(43) Pub. Date: Sep. 18, 2003

(54) Method of securing a machine element and/or a load connected to the machine element in a fixed position

(75) Inventors: Dieter Eckardt, Herzogenaurach (DE); Ronald Hauf, Mohrendorf (DE)

Correspondence Address: Henry M. Feiereisen, Suite 3220, 350 Fifth Avenue, New York, NY, 10118, US

(73) Assignee: SIEMENS AKTIENGESELLSCHAFT, Munchen (DE)

(21) Appl. No.: 10/353,859

(22) Filed: Jan. 29, 2003

(30) Foreign Application Priority Data
Jan. 29, 2002 (DE) 102 03 374.9

(51) Int. Cl. H02P 3/00

(52) U.S. Cl. 318/371

(57) ABSTRACT

In a method of holding a machine element, whose position is directly or indirectly controlled by an electromotive drive in the absence of a self-locking mechanism, the drive is halted and shifted into a standby mode while a brake is activated to maintain the machine element in a fixed position. As soon as a holding position of the altered and exceeds a tolerance value, the machine element is stopped by a type of catch control in which the drive is activated again to catch the machine element or load. The drive is thus a safe drive constructed to securely prevent a re-starting although an inadvertent shutdown is not preventable.

### CROSS-REFERENCES TO RELATED APPLICATIONS

This application claims the priority of German Patent Application, Serial No. 102 03 374.9, filed Jan. 29, 2002, pursuant to 35 U.S.C. 119(a)-(d), the disclosure of which is incorporated herein by reference.

### BACKGROUND OF THE INVENTION

The present invention relates to a method of securing a machine element and/or a load connected to the machine element in a fixed position.

Machine elements involved here do not have a self-locking feature and are operatively connected to an electromotive drive by which the position of the machine element is controlled directly or indirectly. A mechanical holding brake is provided to halt the machine element and/or the load.

Safety measures play an increasingly important role in conjunction with the operation of power machines. Therefore, the European Community established respective standards in 1995, as did the United States and Japan which set equivalent requirements as a consequence of e.g. domestic product liability acts. Safety issues are thus a primary focus of the industrial world market fueling a need for devices and functions that take into account safety requirements. In the field of numeric controls, the safety concept “SINUMERIK SAFETY INTEGRATED®” is predominantly utilized at the present time and is easily applicable also in other fields, e.g. product machines.

Another safety aspect increasingly relevant in industrial plants relates to the field of drives whose axles, shafts or other mechanics are not self-locking when the drive is switched off. In these situations there is a risk of a crash as a result of gravitational forces. Such hazardous movement can develop, for example, when vertical linear axles, in particular suspended axles, or round axles or spindles with asymmetric weight distribution, are involved. Thus, safety concerns demand proper measures to secure such axles or mechanisms in position.

One approach to address these safety concerns involves the use of a continuously active system that mechanically balances the weight. This approach is, however, complicated. Other exceptional cases involve a halting through use of socket pins, underpinning or supports. However, this proposal are targeted only for particular situations, such as reconstructions and start-up. When repeated operative activations are involved, the use of a holding brake or service brake still remains the only option.

Heretofore, a secure hold is realized by halting the electromotive drive which is determinative for the position of the machine element and/or associated load, actuating a mechanical brake to effect a relatively secure hold through frictional engagement, and subsequently switching off the drive. Despite the possibility to perform a constant check of such a brake for proper operation, this approach does not constitute a fool-proof system. While electronic concepts are indeed available to test a secure activation of the brake and it is also possible to test the friction moment in the holding mode, there is still a risk that sudden mishaps, e.g., a completely unexpected oil presence, may cause an abrupt decrease of the braking force. Operators of power machines are aware of this danger for a long time and it has therefore been proposed to use not one but several brakes to meet heightened safety demands during the holding mode. This proposal is, however, very complicated.

It would therefore be desirable and advantageous to provide an improved method for securing a machine element and/or load in a fixed position, to obviate prior art shortcomings and to attain a high degree of safety for holding the machine element and/or load in place.

### SUMMARY OF THE INVENTION

According to one aspect of the present invention, a method of securing in a fixed position a machine element whose position is directly or indirectly controlled by an electromotive drive in the absence of a self-locking mechanism, includes the steps of halting the drive and activating a brake, switching the drive to a standby mode; stopping the machine element through a type of catch control, when a holding position of the machine element changes to exceed a tolerance value, whereby the drive is a safe drive constructed to securely prevent an inadvertent re-starting although an inadvertent shutdown of the drive is not preventable.

Heretofore, conventional wisdom required a complete shutdown of the drive in the holding position as only option because of the consideration that an inadvertent re-starting of the drive poses a threat to the holding system. The present invention now recognizes that such an inadvertent starting can be safely prevented by suitable measures to establish a “secure drive” so that this conventionally perceived threat is no longer an issue. Thus, the drive can be used as redundant, electrical holding system which is completely independent from the mechanical brake and is shifted into a standby operation.

According to another feature of the present invention, the catch control is activated via an autarchically operating controller, when the drive is in standby mode. In this way, even when the control unit fails, a secure hold is still maintained.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a block diagram showing the relationship and operation of the components of an arrangement according to the present invention for securing a component such as a machine element and/or load in a fixed position;

FIG. 2 is a graphical illustration of a time-path diagram showing the relation between path and time of a load during travel and reaching a holding position;

FIG. 2a is an enlarged detailed view of the area encircled in FIG. 2 when a sagging of the load is encountered;

FIG. 2b is a graphical illustration of the situation, when the drive arrests the load; and

FIG. 2c is a graphical illustration of the situation, when the brake is activated.

### DETAILED DESCRIPTION OF PREFERRED EMBODIMENTS

Throughout all the FIGS., same or corresponding elements are generally indicated by same reference numerals. These depicted embodiments are to be understood as illustrative of the invention and not as limiting in any way.

This is one of two applications both filed on the same day. Both applications deal with related inventions. They are commonly owned and have the same inventive entity. Both applications are unique, but incorporate the other by reference. Accordingly, the following U.S. patent application is hereby expressly incorporated by reference: “Method of Securing a Machine Element and/or a Load Connected to the Machine Element in a Fixed Position”.

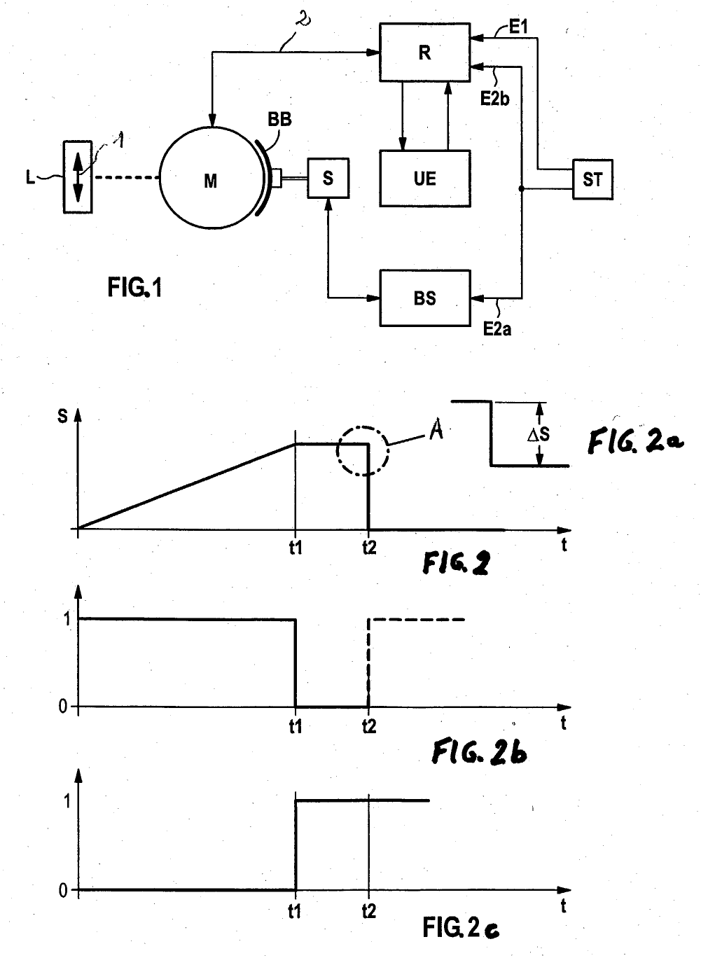

Turning now to the drawing, and in particular to FIG. 1, there is shown a block diagram showing the relationship and operation of the components of an arrangement according to the present invention for securing a component, here by way of example a load L, in a fixed position. The arrangement includes a drive, comprised of a motor M and a controller R, for moving the load L via a gear mechanism as indicated by broken line, in two directions, as indicated by double arrow 1.

A control unit ST delivers desired values representative of a movement of the load to an input El of the controller R which generates electric control signals for transmission to the motor M. At the same time, the motor M feeds back to the controller R position signals and/or movement signals in response to the actual position and/or actual movement of the load L. This interaction between the motor M and the controller R is indicated by double arrow 2. Depending on the desired values delivered by the control unit ST to the controller R, it is possible to lift or lower the load L in vertical direction in a desired manner.

In the event, the load L should be safely held in a predetermined position, a corresponding desired position value is delivered by the control unit ST to the input El of the controller R so as to position the load L accordingly. When the load L has reached this position, a signal flow from the motor M or the controller R is communicated to the control unit ST. This signal flow is not shown in FIG. 1 for ease of illustration. The control unit ST activates a brake control system BS by sending a signal to an input E2a for mechanically braking the motor M via a coil arrangement S and brake shoe BB. Instead of a complete shutdown, the motor M is now shifted into a standby mode whereby the drive represents overall a safe drive, i.e. electronic measures are provided that safeguard the motor M against inadvertent positional changes. A monitoring device UE is connected bi-directionally with the controller R and continuously monitors whether unintended positional changes in the holding mode exceed a predetermined threshold value. In the event, a tolerance value is exceeded, the motor M is activated by the controller R to stop the load L by means of a catch control. In addition to the communication between the control unit ST and the brake control system via the input E2a, the control unit ST further communicates with the controller R via input E2b so that the initiation of a braking action by the control unit ST via input E2a is accompanied by a communication to the controller R that the motor M has been shifted to the standby mode so as to be ready to activate the catch control, if required.

Implementation of a shift of the motor M from an active mode to a stand-by mode is generally known to the person skilled in the art so that a detailed discussion thereof is omitted for the sake of simplicity. The term “catch control” is used in the description to refer to a control mechanism for halting the load L as rapidly as possible by means of the controller R, when dropping beyond a safety level.

Of course, the monitoring device UE may also be connected directly to the control unit ST. However, a direct interaction with the controller R is currently preferred because of the system autarky from the control unit ST. It is also possible for the holding mode to particularly parameterize the controller parameters of the controller R for this mode.

In accordance with the present invention, the load L is held in safe holding position by two completely independent and separate systems, namely the brake system, on the one hand, and the electric position control system in the standby mode of the motor M, on the other hand.

The position control system of the motor M in the standby mode is also shown in the graphical illustrations of FIG. 2, 2a-c. FIG. 2 is a graphical illustration of a time-path diagram showing the relation between path and time of the load L during travel and reaching a holding position, whereas FIGS. 2b, 2c show contemporaneous illustrations relating to an active switching state (logic “1”) and inactive switching state (logic “0”) of the electric braking action (FIG. 2b) and the mechanical braking action (FIG. 2c). As shown in FIG. 2, the load L travels along a path s up to a point in time t1 when the load L should be held in place. At of this point in time t1, the path s remains unchanged, as indicated by the horizontal line. In the event the load L moves in point of time t2 and exceeds a desired threshold value Δs, as shown in FIG. 2a, the drive is activated to initiate corrective measures to catch the load L. This situation is shown in FIG. 2b. Switching states logic “0” and logic “1” indicate, whether the drive is inactive or active during the movement process up to the time t1, while the standby mode is represented by the switching state logic “0”.

Thus, the drive is active (logic “1”) up to the point in time t1 and then switched to logic “0”, as shown in FIG. 2b, while the brake control system BS is inactive (logic “0”) up to the point in time t1, and then activated and switched to logic “1”. The broken line in FIG. 2b indicates the activation of the drive from the standby mode (logic “0”) to logic “1” at point of time t2 to implement the corrective measures, as shown in FIG. 2c. The activation of the mechanical brake at point in time t1 is a conventional step that is also performed by the method according to the present invention. However, as the mechanical brake fails as of point in time t2, —this situation may be signaled optically or acoustically to the operator of the assembly—the corrective measured triggered by the drive are now initiated, when the threshold value Δs is exceeded.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method of holding a machine element, whose position is directly or indirectly controlled by an electromotive drive in the absence of a self-locking mechanism, said method comprising the steps of:
halting the drive and activating a brake to maintain the machine element in a fixed position;
shifting the drive into a standby mode; and
stopping the machine element through a type of catch control, when a holding position of the machine element changes to exceed a tolerance value, whereby the drive is a safe drive constructed to securely prevent a re-starting although an inadvertent shutdown is not preventable.

2. The method of claim 1, wherein the catch control is activated via an autarchically operating controller, when the drive is in standby mode.

3. A method of maintaining a holding position of a component moved by an electromotive drive, comprising the steps of:
halting the drive and shifting the drive to a standby mode while activating a brake to hold the component in a holding position;
monitoring any movement of the component away from the holding position; and
catching the component, when a holding position of the drive exceeds a tolerance value, by shifting the drive from the standby mode into an active mode.

4. The method of claim 3, wherein the catching step involves the use of an autarchically operating controller to activate the drive.
